(19) United States
(12) Patent Application Publication
(10) Pub. No.: US 2026/0201715 A1
(43) Pub. Date: Jul. 16, 2026

(54) A DEVICE FOR PREVENTING ACTUATION OF A TELESCOPIC PROP

(71) Applicant: R.J. Goldspink Pty Limited, NSW South Wales (AU)

(72) Inventor: Robert Goldspink, Mudgee, NSW (AU)

(21) Appl. No.: 19/133,475

(22) PCT Filed: Nov. 28, 2023
(86) PCT No.: PCT/AU2023/051217

§ 371 Date: May 28, 2025

(30) Foreign Application Priority Data
Nov. 28, 2022 (AU) 2022903597

(51) Int. Cl. E04G 25/06

(52) U.S. Cl. CPC E04G 25/063; E04G 25/065

(57) ABSTRACT

Disclosed is a device for preventing actuation of a telescopic prop. The device comprises a body arranged to embrace or enclose and grip an exterior surface of a telescopic prop; and a handle retaining portion for receiving and retaining at least part of a handle of an actuator of the telescopic prop. When the device is positioned on a telescopic prop with the at least part of the handle retained within the handle retaining portion, the handle is prevented from being manipulated in order to actuate the actuator.

A first embodiment includes an adjustable latch attachment to tighten the grip of the two portions of the body on the exterior surface of the telescopic prop. A second embodiment includes an expansion loop and an expansion joint which expand to accommodate the diameter of the telescopic prop.

### CROSS-REFERENCE TO RELATED APPLICATIONS

This application is a National Stage application of International Application No. PCT/AU 2023/051217 filed on Nov. 28, 2023, which claims priority to Australian Patent Application No. 2022903597 filed on Nov. 28, 2022.

### FIELD

The present invention relates to the field of telescopic props. In particular, the present invention relates to a device for preventing actuation of a telescopic prop.

### DISCUSSION OF RELATED ART

The following references to and descriptions of prior proposals or products are not intended to be and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

Telescopic props are used for supporting overhanging loads, for example, holding up unstable beams and joists in construction. The telescopic nature of the props allows them to have their height adjusted to meet the height requirements of the load to be supported. An example of a telescopic prop is disclosed in U.S. Pat. No. 2,468,484 entitled ‘Adjustable Metal Prop’, the disclosure of which is herein incorporated by way of reference.

In use, the telescopic prop is extended to a suitable height and a locking bar is inserted through holes in the prop to maintain the height. A rotatable actuator, arranged on screw threading, is actuated to engage the locking bar and make the final height adjustment until the load is fully supported by the prop.

Given the environments in which telescopic props are used, failure of a prop to support the intended overhanging load can be hazardous, catastrophic and/or fatal. One particular cause for concern is the accidental or malicious rotation of the actuator of a loaded prop.

Prior art attempts to safeguard accidental or malicious rotation of the actuator of a loaded telescopic prop usually involve the use of a lockout device that is mounted or otherwise applied to the telescopic prop and locked to prevent failure of the telescopic prop, or to prevent accidental or malicious rotation of the actuator of the loaded prop. Duct tape or other types of tape are typically used in an attempt to deter manipulation or actuation of a loaded telescopic prop. However, these are ineffective while being difficult to remove in case of an emergency.

The present invention seeks to provide a device which may ameliorate the foregoing shortcomings and disadvantages or which will at least provide a useful alternative.

### SUMMARY

According to one aspect of the invention, there is provided a device for preventing actuation of a telescopic prop, the device comprising: a body arranged to embrace or enclose and grip an exterior surface of the telescopic prop; and a handle retaining portion for receiving and retaining at least part of a handle of an actuator of the telescopic prop; wherein when the device is positioned on the telescopic prop with the at least part of the handle retained within the handle retaining portion, the handle is prevented from being manipulated in order to allow actuation (for example, unwinding or turning) of the actuator.

The body may include one, two or more portions each portion respectively arranged to grip an exterior surface of the telescopic prop. The portions may be arranged to be connected to each other in order to embrace or enclose the telescopic prop. Preferably, the portions are connected to each other. More preferably, portions 34, 36 are connected to each other with a hinge 38 or another suitable coupling. In exemplary embodiments, a latch arrangement releasably connects two portions to each other in order to embrace or enclose the telescopic prop. The body may embrace the exterior surface of the prop without completely enclosing it. It is preferred, however, that the body completely encloses the exterior surface of the prop. The exterior surface of the prop is gripped by a close fit once the portions are connected.

The handle retaining portion is most preferably in the form of a loop formation extending from the body. The handle retaining portion can take various shapes. The shapes shown in the Figures are preferred examples, however the handle retaining portion must be able to retain the handle of the telescopic prop within the device.

In a first embodiment where there are two portions included in the body, the latch arrangement preferably includes a female member 52 on one of the portions 34, 36, and a male member 55 on the other of the portions 34, 36. The female 52 and male 55 members are preferably releasably connectable with one another, and a latch member 60 is preferably provided to reversibly lock the female 52 and male 55 members together. When the portions 34, 36 are releasably connected together the female 52 and male 55 members releasably connect one another and the latch member 60 locks the female 52 and male 55 members together to releasably connect the two portions 34, 36 together. The male member preferably includes a head 58 to engage the female member 52 and a shaft 56 to connect the female 52 and male 55 members. The female member 52 preferably includes a slot 54 for the shaft 56 to pass through. When the portions 34, 36 are releasably connected together the shaft 56 passes through the slot 54 and the head 58 engages the female member 52 so that the female 52 and male 55 members releasably connect one another.

In a second embodiment, the aforementioned features and interrelationships are included, and in addition the latch arrangement 50 is adjustable in order to tighten the grip of the portions 34, 36 on the exterior surface of the telescopic prop 10 when said two portions 34, 36 are latched together.

Most preferably in the second embodiment, the shaft 56 includes a screw thread and is threadedly engaged to the head 58 so that the latch arrangement 50 is adjustable in order to tighten the grip of the portions 34, 36 on the exterior surface of the telescopic prop 10 when the portions 34, 36 are releasably connected together. Both of the first and second embodiments preferably further include a locking arrangement 61 for preventing the release of the latch arrangement 50.

The locking arrangement 61 preferably includes a passage 62 for receiving a locking member 64 such as a padlock or tie. The locking member 64 is received in the passage 62 to prevent the latch arrangement 50 from being released.

The handle retaining portion 44 is most preferably in the form of a loop formation 66 extending from the body 32.

The first embodiment of device 30 preferably further includes an actuator receiving portion 65 which receives at least a part of the actuator 24 when the first embodiment of device 30 is positioned on said telescopic prop 10.

The actuator receiving portion 65 of the first embodiment preferably includes at least one guiding member 46, 48 which receives at least a part of the actuator 24 when the device 30 is positioned on the telescopic prop 10.

The second embodiment of device 30 most preferably further includes an expansion loop 68. The expansion loop 68 includes the handle retaining portion 44 in the form of a loop formation 66 extending from the body 32, and the loop formation 66 has an opening 70 on an inner surface 40, 42 of the body 32, such that when the portions 34, 36 are releasably connected to each other in order to enclose and grip the opposing exterior surface of the telescopic prop 10, the expansion loop 68 expands to accommodate the diameter of the telescopic prop 10.

In the second embodiment of device 30 the opening 70 most preferably further includes an expansion joint 72.

For the second embodiment of device 30 the telescopic prop 10 optionally has a diameter between about 59.5 to 61.5 millimetres.

A device in accordance with the present invention advantageously prevents or at least hinders the actuation of a telescopic prop while loaded as a safety precaution.

### BRIEF DESCRIPTION OF THE DRAWINGS

The invention may be better understood from the following non-limiting description of a preferred embodiment, in which:

FIGS. 1a to 1c illustrate perspective views including detailed views of an example of a known telescopic prop;

FIGS. 2 and 3 show a perspective and top view, respectively, of a first embodiment of the device during latching;

FIGS. 4 and 5 show a perspective and top view, respectively, of the first embodiment of the device fully latched;

FIG. 6 shows a perspective view of the first embodiment of the device being installed on a telescopic prop;

FIG. 7 shows a perspective view of the first embodiment of the device in an open configuration;

FIGS. 8 and 9 show perspective views of the first embodiment of the device fully installed on the telescopic prop;

FIG. 10 shows a perspective view of the second embodiment of the device in an open configuration;

FIG. 11 shows a top view of the second embodiment of the device in an open configuration;

FIG. 12 shows a perspective view of the second embodiment of the device in a partially open/closed configuration;

FIG. 13 shows a top view of the second embodiment of the device in a partially open/closed configuration;

FIG. 14 shows a perspective view of the second embodiment of the device in a closed configuration;

FIG. 15 shows a top view of the second embodiment of the device in a closed configuration;

FIG. 16 shows a top view of the second embodiment of the device in a closed configuration without a telescopic prop present, and with the expansion loop and expansion joint in a non-expanded state;

FIG. 17 shows a top view of the second embodiment of the device in a closed configuration with a telescopic prop present;

FIGS. 18 and 19 show perspective views of the second embodiment of the device being installed on a telescopic prop; and

FIG. 20 shows a perspective view of the second embodiment of the device fully installed on the telescopic prop.

### DETAILED DESCRIPTION OF THE DRAWINGS

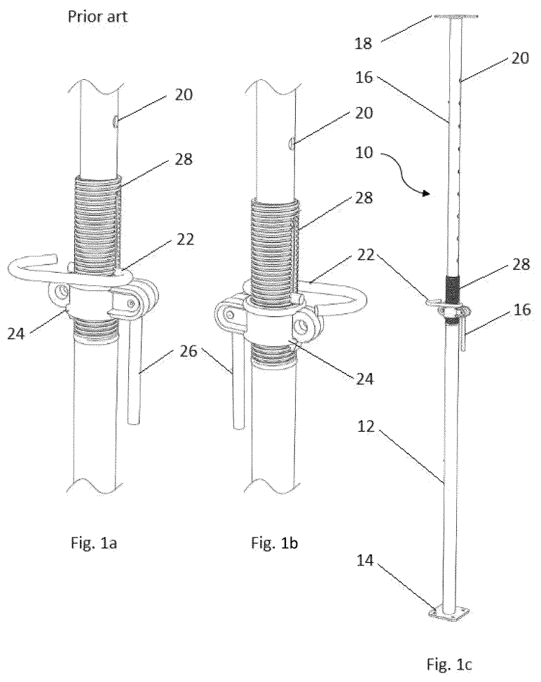

FIGS. 1A to 1C illustrate an example of a telescopic prop 10 for which the first or second embodiments of the device 30 can be employed. The use of the first embodiment of the device 30 with the prop 10 will be described first. The prop 10 has a lower member 12 with a ground engaging foot 14. An upper member 16 with a ceiling engaging foot 18 is slidably arranged within the lower member 12. The upper member 16 has a number of holes 20 arranged along its length. A locking bar 22 is selectively inserted into a hole 20 which meets the approximate height required of the prop 10. A rotatable actuator 24 arranged on screw threading 28 on the prop 10 is designed to engage the locking bar 22. A user manipulates the actuator 24 via a handle 26, which is pivotally arranged to be raised into a use position and hang when not in use. Turning the actuator 24 causes the actuator 24 to raise or lower on the screw threading 28, thereby raising or lowering the locking bar 28. Raising the locking bar 28, causes the upper member 16 to be moved into a fully loaded position. Lowering the locking bar 28, causes the upper member 16 to be moved away from a loaded position.

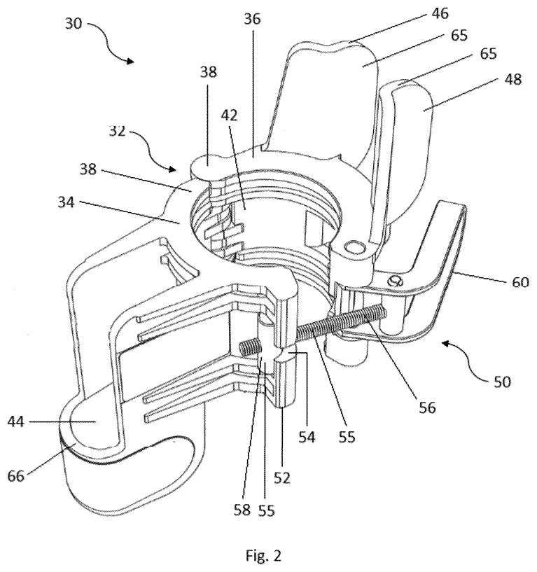

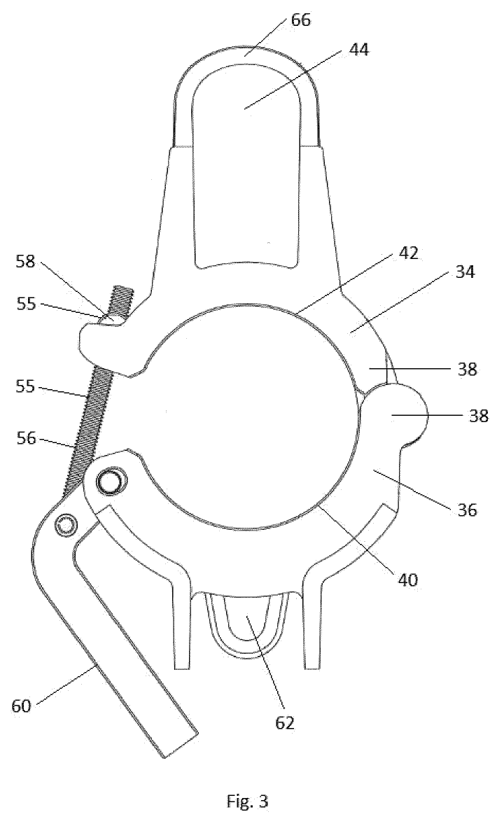

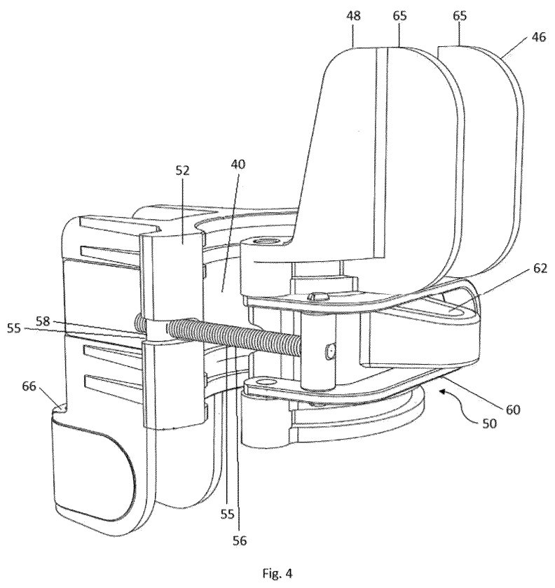

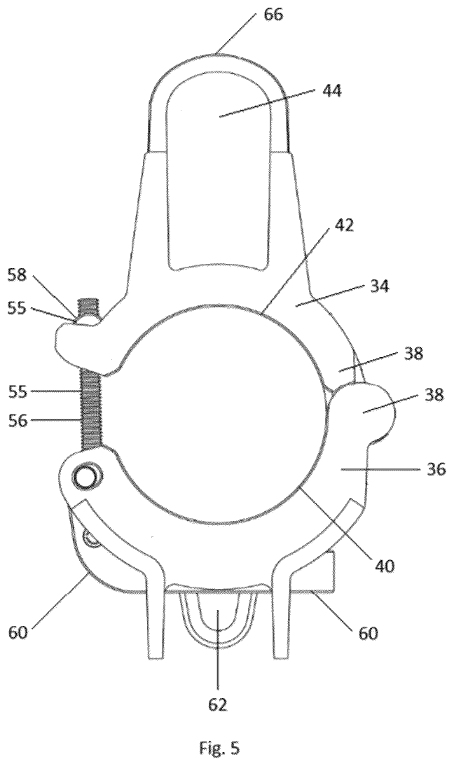

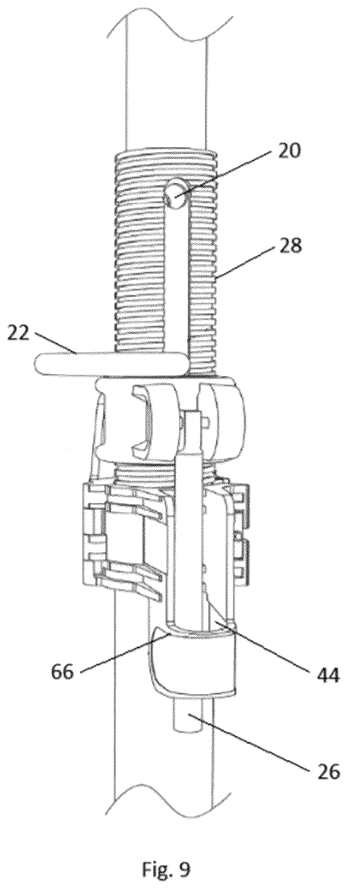

A first embodiment of a device 30 for preventing activation of a telescopic prop 10 is shown in FIGS. 2 to 9.

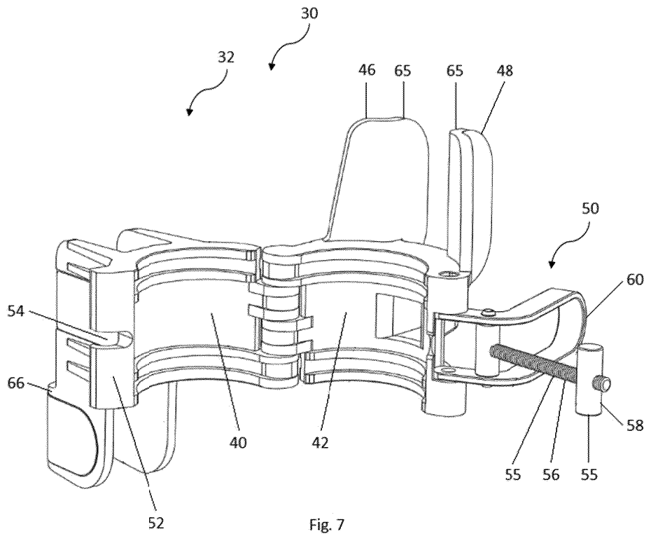

The first embodiment of device 30 has a body 32 shaped and adapted to enclose and grip the exterior surface of a telescopic prop 10. The body 32 is shown formed in two portions 34, 36 hingedly connected to each other, for example by a hinge 38 or another suitable coupling, to allow the two body portions 34, 36 to be moved relative to each other for the purpose of attaching and removing the device 30 to/from a telescopic prop 10 (see FIG. 7). Each body portion 34, 36 has an inner surface 40, 42 shaped to accommodate the exterior surface of the prop 10.

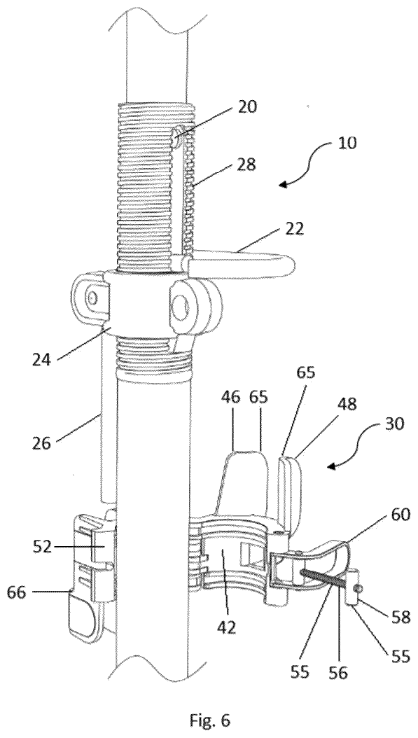

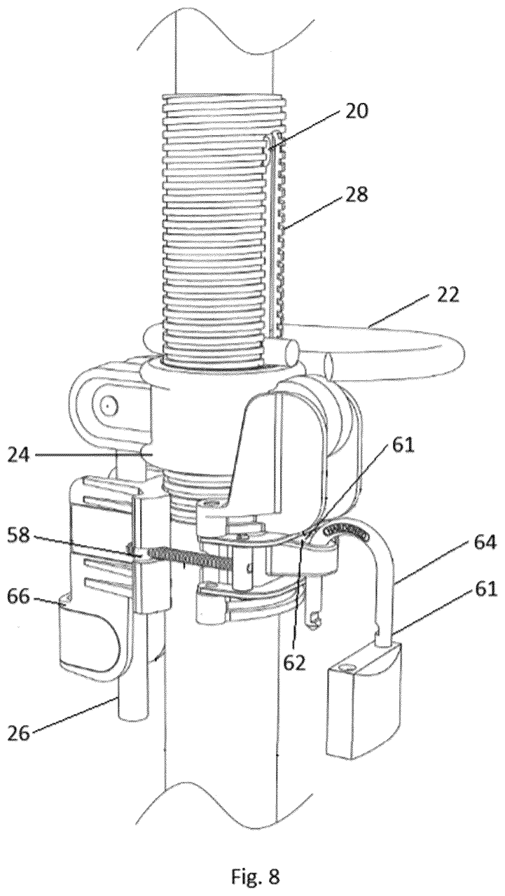

The device 30 includes a handle retaining portion 44. As shown the handle retaining portion 44 takes the form of a loop formation 66 extending from the exterior of the body 32. When placing the device 30 on a prop 10, the device 30 is placed below the actuator 24 and slid up the prop 10, thereby trapping the handle 26 of the actuator 24 within the loop formation 66 of the handle retaining portion 44 (see FIG. 6). Guiding members 46, 48, collectively forming an actuator receiving portion 65, extend from the top of the device 30 and receive at least a part of the actuator 24 when the device 30 is positioned on the telescopic prop 10. For example, the guiding members 46, 48 of the actuator receiving portion 65 receive a flange portion of the actuator 24 in between the guiding members 46, 48 of the actuator receiving portion 65 to assist in properly positioning the device 30 with respect to the actuator 24 and offering an additional engagement with the actuator 24 (see FIG. 8).

A latch arrangement 50 releasably allows the two body potions 34, 36 to be retained in a closed configuration, thereby enclosing the prop 10 and gripping the surface of the prop 10. The latch arrangement 50, as shown, includes a female member 52 having a slot 54 arranged on one of the body portions 34. A complementary male member 55 is arranged on the other body member 36. Alternately, the female member 52 having a slot 54 can be arranged on the body portion 36, and the male member 55 can be arranged on the other body member 34. The female 52 and male 55 members are releasably connectable with one another. The male member 55 includes a shaft 56, which passes through and mates with the slot 54 in the female member 52, and a head 58 which rests against the female member 52. The male member 55 is pivotally arranged on a latch member 60, to reversibly lock or to release and secure the male 55 and female 52 connection. In the device 30, the latch arrangement 50 is adjustable in order to tighten the grip of said two portions 34, 36 on the exterior surface of said telescopic prop 10 when said two portions 34, 36 are latched together. Ideally, as shown, the head 58 and shaft 56 are arranged in a screw-threaded manner so that the connection can be tightened to firmly secure the device 30 to the prop 10 and improve the grip of the device 30 on the exterior surface of the prop 10.

The device 30 further includes a locking arrangement 61 for preventing the release of said latch arrangement 50.

The locking arrangement 61 includes a passage 62 arranged to receive some form of locking device 64, such as a padlock or tie (see FIG. 8). The passage 62 is positioned such that, when the latch member 60 is in the connected position and a locking device 64 is received in the passage 62, the locking device 64 prevents the latch member 60 from being moved into a release position.

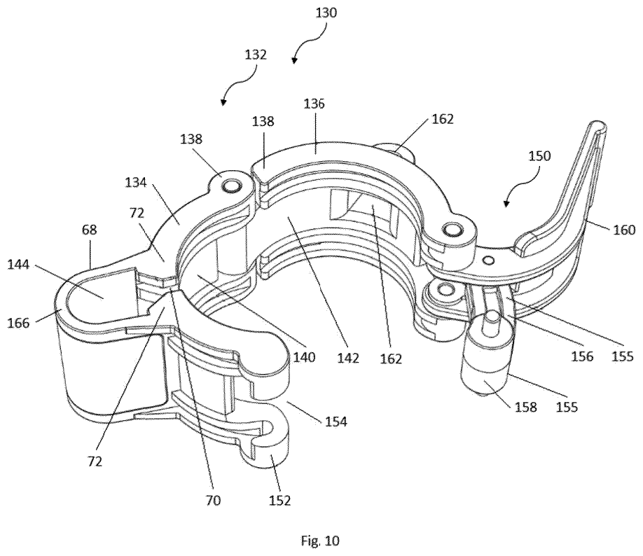

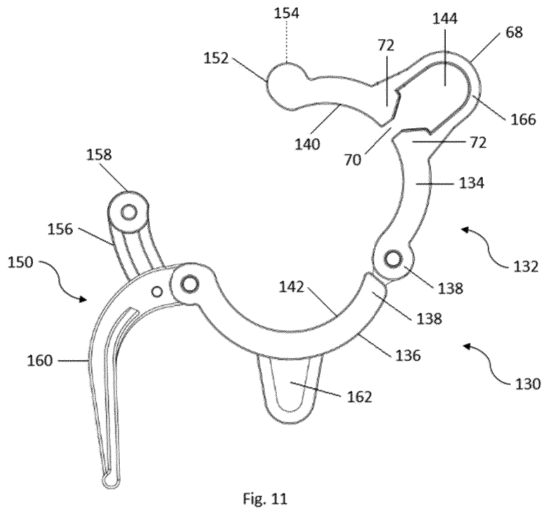

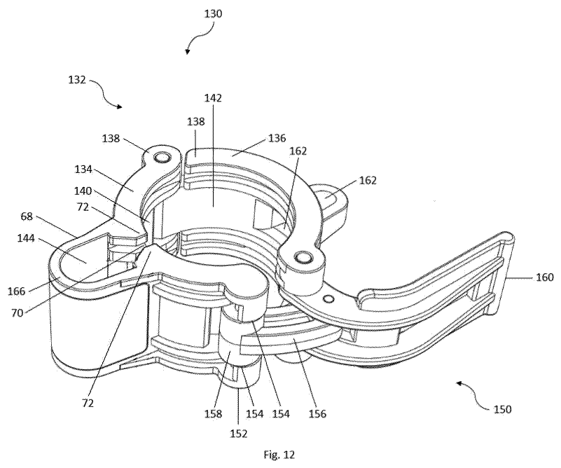

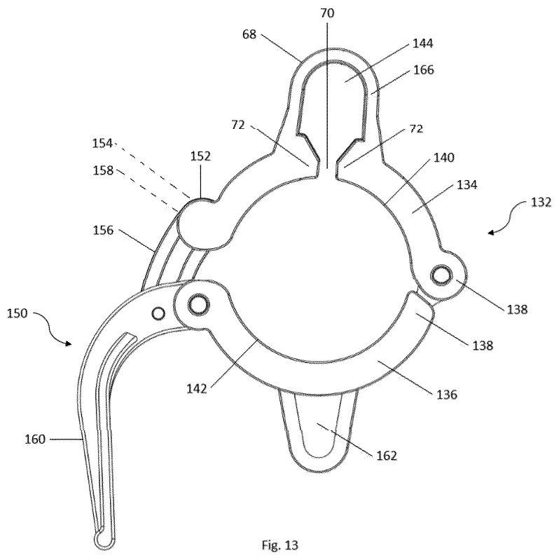

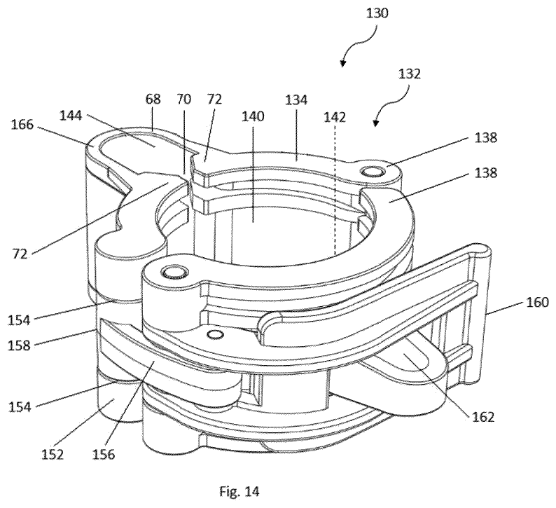

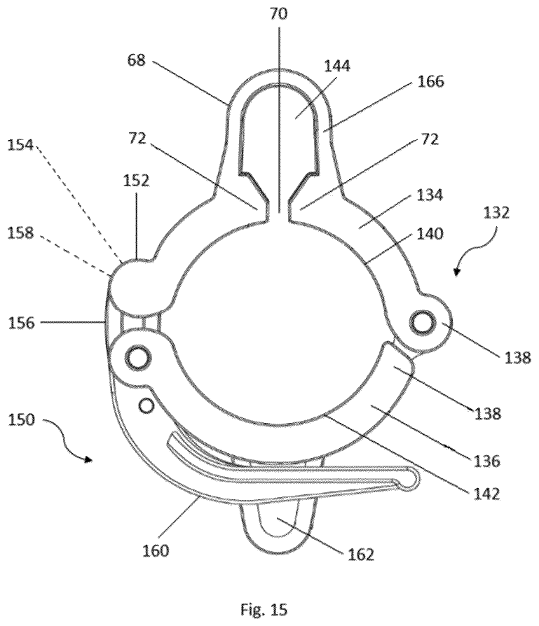

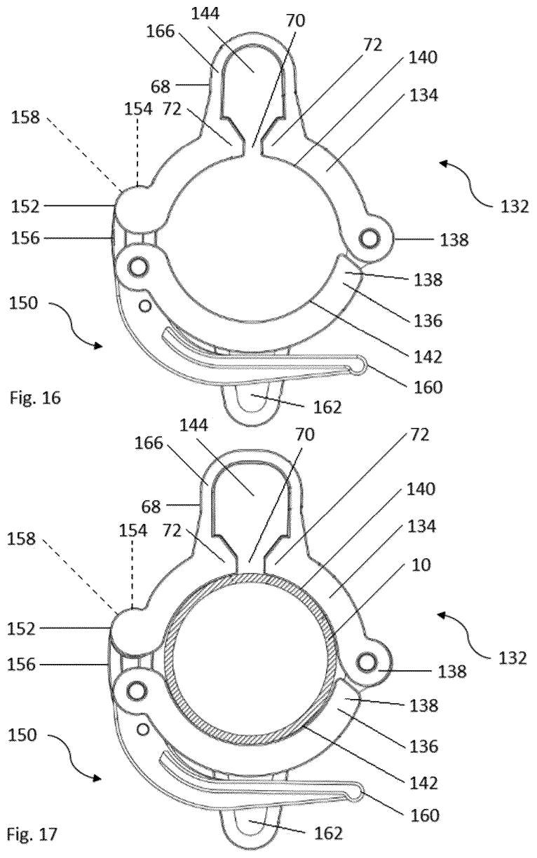

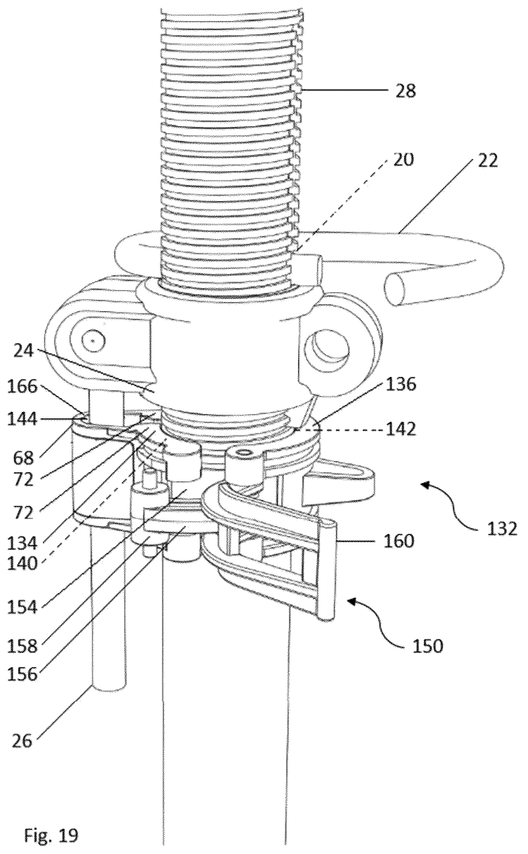

A second embodiment of a device 130 for preventing activation of a telescopic prop 10 is shown in FIGS. 10 to 20.

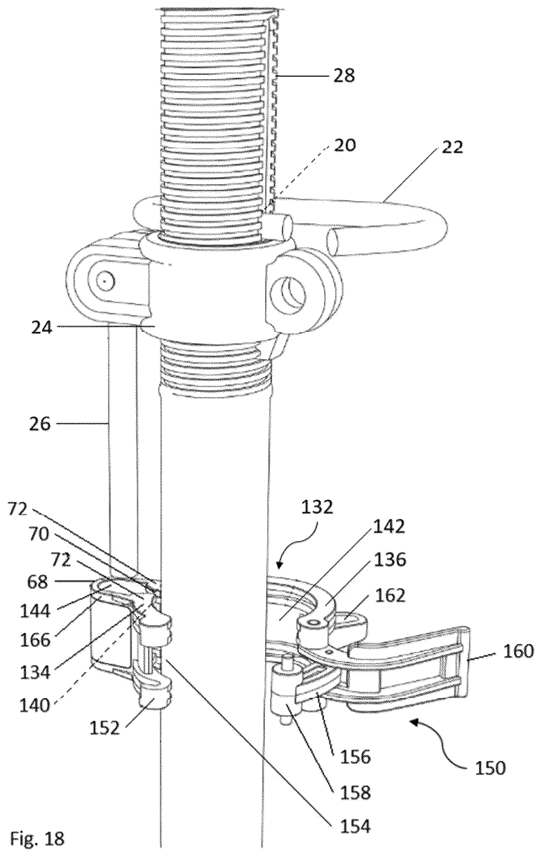

FIGS. 18 to 20 illustrate an example of telescopic prop 10 for which the second embodiment of device 130 can also be employed. The prop 10 has a lower member 12 with a ground engaging foot 14. An upper member 16 with a ceiling engaging foot 18 is slidably arranged within the lower member 12. The upper member 16 has a number of holes 20 arranged along its length. A locking bar 22 is selectively inserted into a hole 20 which meets the approximate height required of the prop 10. A rotatable actuator 24 arranged on screw threading 28 on the prop 10 is designed to engage the locking bar 22. A user manipulates the actuator 24 via a handle 26, which is pivotally arranged to be raised into a use position and hang when not in use. Turning the actuator 24 causes the actuator 24 to raise or lower on the screw threading 28, thereby raising or lowering the locking bar 28. Raising the locking bar 28, causes the upper member 16 to be moved into a fully loaded position. Lowering the locking bar 28, causes the upper member 16 to be moved away from a loaded position.

The device 130 has a body 132 shaped and adapted to enclose and grip the exterior surface of a telescopic prop 10. The body 132 is shown formed in two portions 134, 136 hingedly connected to each other, for example by a hinge 138, to allow the two body portions 134, 136 to be moved relative to each other for the purpose of attaching and removing the device 130 to/from telescopic prop 10 (see FIGS. 10 to 20). Each body portion 134, 136 has an inner surface 140, 142 shaped to accommodate the exterior surface of the prop 10.

The device 130 includes a handle retaining portion 144. As shown the handle retaining portion 144 takes the form of a loop formation 166 extending from the exterior of the body 132. When placing the device 130 on prop 10, the device 130 is placed below the actuator 124 and slid up the prop 10, thereby trapping the handle 126 of the actuator 124 within the loop formation 166 of the handle retaining portion 144 (see FIGS. 17 to 20).

A latch arrangement 150 releasably allows the two body potions 134, 136 to be retained in a closed configuration, thereby enclosing the prop 10 and gripping the surface of the prop 10. The latch arrangement 150, as shown, includes a female member 152 having a slot 154 arranged on one of the body portions 134. A complementary male member 155 is arranged on the other body member 136. Alternatively, the female member 152 having a slot 154 can be arranged on the body portion 136, and the male member 155 can be arranged on the other body member 134. The female 152 and male 155 members are releasably connectable with one another. The male member 155 includes a shaft 156, which passes through and mates with the slot 154 in the female member 152, and a head 158 which rests against the female member 152. The male member 155 is pivotally arranged on a latch member 160, to reversibly lock or to release and secure the male 155 and female 152 connection. In the device 130, the latch arrangement 150 is adjustable in order to tighten the grip of said two portions 134, 136 on the exterior surface of said telescopic prop 10 when said two portions 134, 136 are latched together. Ideally, as shown, the head 158 and shaft 156 are arranged in a screw-threaded manner so that the connection can be tightened to firmly secure the device 130 to the prop 10 and improve the grip of the device 130 on the exterior surface of the prop 10.

The device 130 further includes a locking arrangement 161 for preventing the release of said latch arrangement 150.

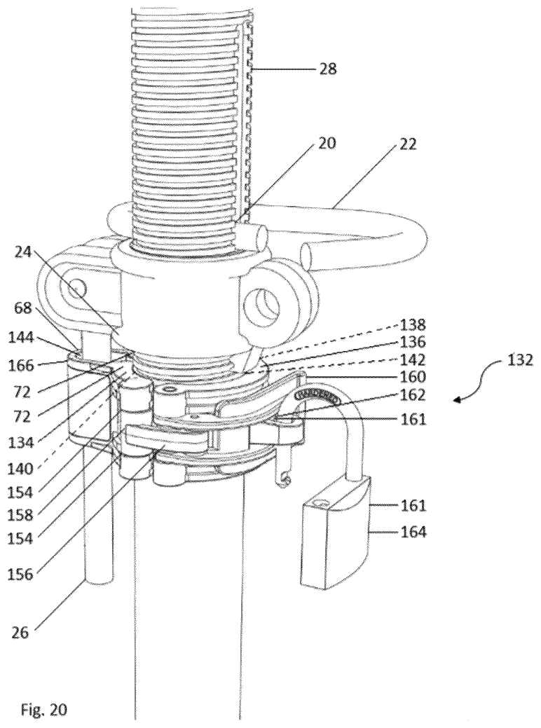

The locking arrangement 161 includes a passage 162 arranged to receive some form of locking device 164, such as a padlock or tie (see FIG. 20). The passage 162 is positioned such that, when the latch member 160 is in the connected position and a locking device 164 is received in the passage 162, the locking device 164 prevents the latch member 160 from being moved into a release position.

The device 130 further includes an expansion loop 68. The expansion loop 68 includes the handle retaining portion 144 in the form of the loop formation 166 extending from the body 132, the loop formation 166 having an opening 70 on an inner surface 140, 142 of the body 132, such that when the two portions 134, 136 are releasably connected to each other in order to enclose and grip the opposing exterior surface of the telescopic prop 10, the expansion loop 68 expands to accommodate the diameter of the telescopic prop 10. The opening 70 further includes an expansion joint 72.

The device 130 does not enclose the exterior surface of the prop but rather embraces it.

Telescopic props 10 that the device 130 are likely to be used with have a diameter between about 59.5 to 61.5 millimetres. Furthermore, and ideally, the device 130 may be designed to fit most common adjustable construction props, and all adjustable props that are 59.5 to 61.5 millimetres in diameter.

The components of the device 30/130 can be formed from a variety of suitable materials employing suitable manufacturing techniques. Ideal materials include rubber, plastic, nylon with glass fibres, alloys and steels.

The term “comprise” and variants of that term such as “comprises” or “comprising” are used herein to denote the inclusion of a stated integer or integers but not to exclude any other integer or integers, unless in the context or usage an exclusive interpretation of the term is required.

Those skilled in the art will appreciate that the invention described herein is susceptible to variations and modifications other than those specifically described. All such variations and modifications are to be considered within the scope and spirit of the present invention the nature of which is to be determined from the foregoing description.

### INDUSTRIAL APPLICABILITY

Now that two embodiments of the present invention have been described in some detail, it will be apparent to a skilled person in the art that embodiments of the device of the present invention may offer at least the following advantages:

(1) prevent the failure of a telescopic prop, in the environments in which telescopic props are used, to support the intended overhanging load, where such failures can be hazardous, catastrophic and/or fatal;

(2) prevent the accidental or malicious rotation of the actuator of a loaded telescopic prop; and

(3) prevent or at least hinder the actuation of a telescopic prop while loaded, as a safety precaution.

1. A device for hindering or preventing actuation of a telescopic prop, the device 30 comprising:
a body arranged to embrace or enclose and grip an exterior surface of the telescopic prop; and
a handle retaining portion for receiving and retaining at least part of a handle of an actuator of said telescopic prop;
wherein when said device is positioned on the telescopic prop with said at least part of said handle retained within the handle retaining portion, said retained handle is prevented from being manipulated in order to actuate the actuator.

2. The device of claim 1, wherein said body includes two portions, each portion respectively arranged to grip an exterior surface of said telescopic prop, said two portions arranged to be connected to each other in order to embrace or enclose the telescopic prop.

3. The device of claim 2, wherein said two portions are connected to each other.

4. The device of claim 3, wherein said two portions are connected to each other by a hinge or other suitable coupling.

5. The device of claim 2, including a latch arrangement to releasably connect said two portions to each other in order to enclose the telescopic prop.

6. The device of claim 5, wherein said latch arrangement includes a female member on one of said two portions, and a male member on the other of said two portions, wherein said female and male members are releasably connectable with one another, and a latch member to reversibly lock said female and male members together, whereby when said two portions are releasably connected together said female and male members releasably connect one another and said latch member reversibly locks said female and male members together to releasably connect said two portions together.

7. The device of claim 6, wherein said male member includes a head to engage said female member and a shaft to connect said female and male members, and said female member includes a slot for said shaft to pass through, whereby when said two portions are releasably connected together said shaft passes through said slot and said head engages said female member so that said female and male members releasably connect one another.

8. The device of claim 7, wherein said latch arrangement is adjustable in order to tighten the grip of said two portions on the exterior surface of said telescopic prop when said two portions are latched together.

9. The device of claim 8, wherein said shaft includes a screw thread and is threadedly engaged to said head so that said latch arrangement is adjustable in order to tighten the grip of said two portions on the exterior surface of said telescopic prop when said two portions are releasably connected together.

10. The device of claim 5, further including a locking arrangement for preventing the release of said latch arrangement.

11. The device of claim 10, wherein said locking arrangement includes a passage for receiving a locking member, whereby a locking member being received in said passage prevents said latch arrangement from being released.

12. The device of claim 1, wherein said handle retaining portion is in the form of a loop formation extending from said body.

13. The device of claim 1, wherein said device further includes an actuator receiving portion which receives at least a part of said actuator when said device is positioned on said telescopic prop.

14. The device of claim 13, wherein the actuator receiving portion includes at least one guiding member which receives at least a part of said actuator when said device is positioned on said telescopic prop.

15. The device of claim 12, further including an expansion loop, the expansion loop including:
said handle retaining portion in the form of a loop formation extending from said body,
said loop formation having an opening on an inner surface of said body, such that
when said two portions are releasably connected to each other in order to enclose and grip the opposing exterior surface of said telescopic prop, the expansion loop expands to accommodate the diameter of the telescopic prop.

16. The device of claim 14, wherein said opening further includes an expansion joint.

17. The device of claim 1, wherein said telescopic prop has a diameter between about 59.5 to 61.5 millimetres.
